(19) United States
(12) Patent Application Publication
(10) Pub. No.: US 2003/0086835 A1
(43) Pub. Date: May 8, 2003

(54) Catalyst for automobile

(76) Inventors: Takumi Suzawa, Okazaki-City (JP); Masakazu Tanaka, Okazaki-City (JP); Kazuhiko Koike, Nishio-shi (JP); Jun Hasegawa, Hekinan-City (JP)

Correspondence Address: Nixon & Vanderhye P.C., 8th Floor, 1100 North Glebe Road, Arlington, VA, 22201-4714, US

(21) Appl. No.: 10/285,583

(22) Filed: Nov. 1, 2002

(30) Foreign Application Priority Data
Nov. 5, 2001 (JP) 2001-339028

(51) Int. Cl. B01D 53/56

(52) U.S. Cl. 422/180; 422/171; 422/172; 422/177

(57) ABSTRACT

It is an object of the present invention to realize an oxidizing catalyst having weak oxidizing capability such that NO is oxidized to NO₂ and HC is not oxidized, and high thermal durability, and to use it as a catalyst in a preceding stage for supplying NO₂ and HC stably to a catalyst in the following stage.

According to the present invention, in an exhaust gas pipe P of a vehicle engine E, a low activity NO oxidizing catalyst 1 is provided on the upstream side and a NOx selective reduction type catalyst 2 is provided on the downstream side. By introducing substituent elements into a substrate ceramic such as cordierite, the catalyst component can be chemically bonded to the substituent elements to obtain a directly supported catalyst which has excellent bonding capability, so that the catalyst component can be highly dispersed and is not easily deteriorated. Therefore, even if amount of supported catalyst is decreased to obtain a desired low activity, the oxidizing capability can be maintained, and NO₂, and HC as a reducing agent, can be stably supplied to a NOx selective reduction type catalyst 2.

### BACKGROUND OF THE INVENTION

1. Field of the Invention

The present invention relates to a catalytic body, for an automobile, used for cleaning an exhaust gas produced by an internal combustion engine of an automobile.

2. Description of the Related Art

Development of a catalyst system for cleaning an exhaust gas from an internal combustion engine is progressing from the viewpoint of protecting the global environment. As a catalytic body for an automobile used in this catalyst system, conventionally, a three way catalyst has been widely used in a gasoline engine. This catalyst can efficiently clean HC, CO and NOx near the stoichiometric air-to-fuel ratio. On the other hand, for a diesel engine or a lean burn engine, the oxygen concentration in the exhaust gas is so high that a three way catalyst is not applicable and various NOx catalysts have been proposed for reducing NOx in the exhaust gas. For a diesel engine, which is advantageous for low fuel cost and low CO₂ emission, but which contains particulate matter such as soot in the exhaust gas, a particulate filter for collecting particulate matter is required to burn and thus remove the particulate matter from the exhaust gas.

As a catalyst for NOx, a NOx selective reduction type catalyst has been known which uses a reducing agent such as HC to reduce and clean NOx. A NOx catalyst system in which an oxidizing catalyst is provided in the preceding stage for converting NO in an exhaust gas into NO₂, and supplying it to the following stage, has been proposed. In this system, highly reactive NO₂ is supplied to the NOx selective reduction type catalyst in the following stage so that an improvement in NOx conversion efficiency can be expected.

A particulate filter (DPF) is generally constructed such that pores of a ceramic honeycomb structure are alternately sealed at both ends so as to capture soot from an exhaust gas which is passing through porous partition walls. Regeneration of a DPF is usually carried out by periodically heating, it at regular intervals, to burn the soot. A DPF system in which an oxidizing catalyst is provided in the preceding stage for converting NO in an exhaust gas into NO₂ to use the NO₂ for oxidizing soot, is known. In this system, NO₂ is used as an oxidizing agent so that regeneration can be carried out at a lower temperature.

It is desirable that the oxidizing catalyst provided in the preceding stage which precedes the NOx selective reduction type catalyst is capable of oxidizing NO to NO₂, and at the same time the reactivity is so low that it is incapable of oxidizing HC. Then, HC in the exhaust gas can be utilized as a reducing agent. Such a low reactivity is also desirable for an oxidizing catalyst provided in the preceding stage which precedes a DPF, since NO₂ can then be stably supplied to the DPF in the following stage, and the effect of suppressing generation of sulfates, from the system as a whole, can be expected.

To obtain the desired low reactivity of the oxidizing catalyst provided in the preceding stage, it is usually necessary to decrease the amount of the oxidizing catalyst supported thereon. However, if the amount of supported catalyst is insufficient, deterioration of catalyst directly leads to lowering of oxidizing activity and, hence, to insufficient oxidation of NO. As a result, the supply of a sufficient amount of NO₂ may become impossible and system thus has poor durability. On the other hand, if the amount of supported catalyst is increased to achieve high durability, a desired low reactivity cannot be obtained and sufficient supply of unoxidized HC, that serves as a reducing agent for the NOx selective reduction type catalyst in the following stage, may become difficult. Therefore, it is desired that an oxidizing catalyst with low reactivity be developed such that both the desired catalytic activity and the durability of the system can be achieved simultaneously.

### SUMMARY OF THE INVENTION

Thus, it is an object of the present invention to provide an oxidizing catalyst which has weak oxidizing activity such that it is capable of oxidizing NO to NO₂, but is incapable of oxidizing HC, and which is capable of suppressing the deterioration of catalytic activity and sustaining the oxidizing activity, and to realize, by incorporating this catalyst in the preceding stage, a catalyst for an automobile which has both high cleaning capability and high thermal durability.

According to a first aspect of the invention, there is provided a catalyst for an automobile comprising a plurality of catalytic bodies provided in an exhaust gas passageway of a vehicle internal combustion engine with oxidizing catalytic bodies having low activity among said plurality of catalytic bodies being disposed on the upstream side and supplying the partly oxidized exhaust gas to the catalytic bodies on the downstream side, characterized in that above-mentioned catalytic bodies on the upstream side are directly supported catalystic bodies which use ceramic supports capable of directly supporting the catalyst on the surface of substrate ceramics, and which directly supports catalyst component having low oxidizing activity on the ceramic support.

As, in accordance with above construction, the oxidizing catalytic bodies having low activity and disposed on the upstream side are directly supported catalystic bodies, the catalyst component can be highly dispersed so that high catalytic performance may be obtained with a small amount of supported catalyst. In conventional catalytic bodies in which a coating layer such as γ-alumina is formed on support surface for supporting a catalyst component, a required amount of catalyst is inevitably increased, and the catalyst component moves during heating and is easily deteriorated due to an increase in particle diameter. In contrast, in a directly supported catalyst, the catalyst component is directly supported, for example, by chemical bonding, so that strength of the bonding is high and deterioration of catalyst due to the growth of particles can be suppressed. Therefore, even if the amount of supported catalyst is reduced to obtain a desired low activity, a sufficient oxidizing capability can be sustained and high cleaning capability as a catalytic system as a whole can be maintained for a long period. Further, as directly supported catalyst has no coating layer, it has a reduced thermal capacity and a reduced pressure loss and thus can be activated quickly.

According to a second aspect of the invention, there is provided a catalyst for an automobile comprising an integral multiple-stage catalyst which integrates a plurality of catalytic layers in one unit disposed in an exhaust gas passageway of an internal combustion engine of a vehicle, and in which an oxidizing catalytic layer of low activity is disposed in the preceding stage on the upstream side for partially oxidizing the exhaust gas and supplying it to the catalytic layer in the following stage on the downstream side, characterized in that above-mentioned catalytic layer in the preceding stage is a directly supported catalyst in which a ceramic support capable of directly supporting catalyst is used on the substrate ceramics surface and a catalyst component having low oxidizing activity is directly supported on the ceramic support.

In this catalytic system having an integral multiple-stage catalyst, as in the construction according to the first aspect, an oxidizing catalyst having a low oxidizing activity and a high resistance to deterioration can be obtained by using a directly supported catalyst as the catalytic layer in the preceding stage. Thus, a catalyst for an automobile having both a high cleaning capability and high thermal durability can be realized.

In the catalyst for an automobile according to the present invention, the above-mentioned catalytic body on the upstream side or the above-mentioned catalytic layer in the preceding stage has low oxidizing activity such that NO in the exhaust gas can be oxidized to NO₂ and at least part of HC in the exhaust gas can be supplied unoxidized to above-mentioned catalytic body on the downstream side or above-mentioned catalytic layer in the following stage. By selecting a weak oxidizing capability such that NO can be oxidized and oxidation of HC can be suppressed, NO₂ can be stably supplied to the catalyst in the following stage, and production of sulfates due to the oxidation of sulphur can be suppressed.

Above-mentioned catalytic body on the downstream side or above-mentioned catalytic layer in the following stage may be a NOx selective reduction type catalyst which cleans NO₂ supplied from above-mentioned catalytic body on the upstream side or above-mentioned catalytic layer in the preceding stage by reduction of HC in the exhaust gas. For cleaning NOx, it is effective to convert NO to the more reactive NO₂. By leaving HC unoxidized, HC can be efficiently utilized as a reducing agent. Thus, NOx can be cleaned with high efficiency for a long period.

Further, the above-mentioned catalytic body on the downstream side or the above-mentioned catalytic layer in the following stage may be a particulate filter which uses NO₂ supplied from the above-mentioned catalytic body on the upstream side or the above-mentioned catalytic layer in the preceding stage, as an oxidizing agent, for burning captured soot in the exhaust gas. The present invention can be applied to a particulate filter to supply NO₂ generated by the oxidizing catalyst on the upstream side to burn captured soot efficiently at low temperature for a long period.

Noble metal elements or base metal elements may be used as the oxidizing catalyst component supported by above-mentioned catalytic body on the upstream side or above-mentioned catalytic layer in the preceding stage.

The oxidizing catalyst component supported by the above-mentioned catalytic body on the upstream side or the above-mentioned catalytic layer in the preceding stage may contain noble metal elements. A desired low oxidizing activity can be hereby obtained with the supported amount of 0.05-1.0 g/L.

The oxidizing catalyst component supported by above-mentioned catalytic body on the upstream side or above-mentioned catalytic layer in the preceding stage may contain base metal elements. A desired low oxidizing activity can be hereby obtained with a supported amount of 0.05-10 g/L.

In the present invention, and preferably in the above-mentioned ceramic support, at least one or more of the elements constituting the substrate ceramics are substituted by elements other than the constituting elements such that the catalyst component can be directly supported on these substituent elements. The above-described directly supported catalyst is obtained by supporting the catalyst component on such a ceramic support.

In this case, the above-mentioned catalyst component is preferably supported on the above-mentioned substituent elements via chemical bond. If the catalyst component is chemically bound to the ceramic support, the holding capability of the support is improved, and the catalyst component is more homogeneously dispersed on the support. As a result, it tends to agglomerate less, and the deterioration due to long use becomes small.

One or more elements having d-orbit or f-orbit in the electronic configuration may be used as the above-mentioned substituent elements. Elements having d-orbits or f-orbits are more easily bound with catalyst components, and hence are preferred.

In the present invention, a support which has a large number of fine pores capable of directly supporting the catalyst on the surface of the substrate ceramics and which is thus capable of directly supporting the catalyst component on these fine pores may be used as above-mentioned ceramic support. Specifically, the above-mentioned fine pores consist of at least one of lattice defects of ceramic crystal lattice, fine cracks formed on the surface of ceramics, and vacancies of elements constituting the ceramics. It is preferable for ensuring sufficient strength of the support that width of the above-mentioned fine cracks is 100 nm or less. In order to be capable of supporting catalyst component, the above-mentioned fine pores must have a diameter or a width not greater than 1000 times the diameter of an ion of the catalyst to be supported. Then, if the number of the fine pores is 1×10¹¹/L or more, the support is capable of supporting about same amount of catalyst component as has been supported previously.

In the present invention, the above-mentioned ceramic support may be constructed from substrate ceramics with cordierite as main component formed into honeycomb shape. Improved thermal shock resistance can be obtained by using cordierite.

### BRIEF DESCRIPTION OF THE DRAWINGS

FIG. 1a is a schematic view showing overall construction of a catalyst for an automobile according to a first embodiment of the present invention;

FIG. 1b is a schematic view showing essential part of a catalyst for an automobile according to a second embodiment of the present invention;

FIG. 2a is a view showing the relation between the supported amount of Pt and the conversion efficiency of NO;

FIG. 2b is a view showing the relation between the supported amount of Pt and conversion efficiency of HC;

FIG. 3 is a view showing the relation between the supported amount of Pt and conversion efficiency of NOx;

FIG. 4a is a view showing the relation between the supported amount of Cu and the conversion efficiency of NO;

FIG. 4b is a view showing the relation between the supported amount of Cu and conversion efficiency of HC;

FIG. 5a is a schematic view showing overall construction of a catalyst for an automobile according to a third embodiment of the present invention; and

FIG. 5b is a schematic view showing essential part of a catalyst for an automobile according to a fourth embodiment of the present invention.

### DESCRIPTION OF THE PREFERRED EMBODIMENTS

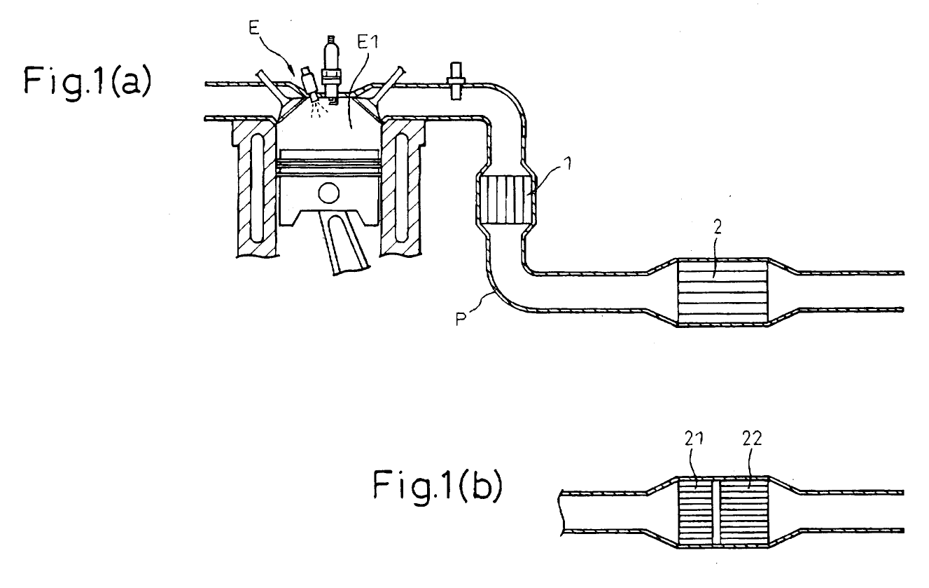

A first embodiment of the present invention will now be described with reference to the drawings. FIG. 1(a) is a schematic view showing the overall construction of a catalyst for an automobile to which the present invention is applied. An exhaust pipe P is connected to combustion chamber E1 of a vehicle diesel engine or lean burn engine E as a passageway for an exhaust gas and, midway from the upstream side, a low activity NO oxidizing catalyst 1 (the catalytic body on the upstream side) and a NOx selective reduction type catalyst 2 (the catalytic body on downstream side) are disposed. The low activity NO oxidizing catalyst 1 is disposed at a location at relatively high temperature directly downstream of an exhaust manifold, and is formed smaller than the NOx selective reduction type catalyst 2. The NO oxidizing catalyst 1 has a low oxidizing activity such that it can oxidize NO in the exhaust gas from the engine E and convert NO to NO₂, and supplies the generated NO₂ to the NOx selective reduction type catalyst 2 on the downstream side. The NOx selective reduction type catalyst 2 reduces supplied NO₂ using HC contained in the exhaust gas from the engine E as a reducing agent, thereby making it harmless.

The NO oxidizing catalyst 1 is a directly supported catalyst consisting of a ceramic support capable of directly supporting a catalyst on the surface of the substrate ceramic, and catalyst component directly supported on the ceramic support. As the catalyst component, one or more of noble metals Pt, Rh, PD, etc., or base metals Cu, Fe, Ni, etc., can be used, and the supported amount is adjusted to obtain a low oxidizing capability such that it is capable of oxidizing NO to NO₂, and can supply at least a part of HC unoxidized to the catalyst on downstream side. The supported amount varies depending upon the type of catalyst component. In general, the more the supported amount, the greater is the conversion efficiency from NO to NO₂. However, since an excessive amount of the catalyst component increases oxidation of HC, the supported amount needs to be set so as to balance the NO conversion efficiency with the HC conversion efficiency. The range of the preferable supported amount will be described later.

As the substrate of the ceramic support, for example, a ceramic having cordierite, with theoretical composition expressed as 2MgO·2Al₂O₃·5SiO₂, as a main component, may be used. This substrate ceramic is formed into a honeycomb structure having a multiplicity of flow channel in the direction of gas flow, and is fired to obtain a ceramic support. Cordierite has excellent heat resistance, and can be advantageously used as a catalyst support disposed in a high temperature exhaust pipe P. The substrate ceramic is not restricted to cordierite, and other ceramics such as alumina, spinel, aluminium titanate, silicon carbide, mullite, silica-alumina, zeolite, zirconia, silicon nitride, zirconium phosphate, may be used. The form of the support is not restricted to a honeycomb shape, and other forms such as pellets, powders, foams, hollow fibers, fibrous forms, etc., may be used.

The ceramic support has many elements that are capable of directly supporting the catalyst component on the surface of the substrate ceramics, and is therefore capable of directly supporting the catalyst metal an these elements. More specifically, the support may be a ceramic support having many elements which are capable of directly supporting catalyst disposed on ceramic surface by substitution of elements. With these substituted elements, the support is capable of supporting catalyst component without forming a coating layer of γ-alumina etc., having a high specific area. Elements which are substituted for ceramic constituting elements, for example, in the case of cordierite, substituted for the constituting elements except oxygen, that is, for Si, Al, Mg, are preferably those elements that are more strongly bound to catalyst components than the ceramic constituting elements, and are therefore capable of supporting the catalyst via chemical bonding. More specifically, those elements other than the ceramic constituting element which have d-electron orbit or f-electron orbit in its electronic configuration, and preferably those elements which have vacant d-orbit or vacant f-orbit, or have two or more oxidation states, are used. Elements which have vacant d-orbit or vacant f-orbit have energy levels close to those of supported catalyst components, and are therefore easy to be bound to the catalyst component since an electron can be easily transferred between them. The same effect can be expected from elements which have two or more oxidation states, since an electron can be easily transferred.

Specific examples of elements which have vacant d-orbit or vacant f-orbit include W, Ti, V, Cr, Mn, Fe, Co, Ni, Zr, Mo, Ru, Rh, Ce, Ir, Pt, etc. At least one or more of these elements may be used. Among these elements, W, Ti, V, Cr, Mn, Fe, Co, Mo, Ru, Rh, Ce, Ir, Pt are elements which have two or more oxidation states. Other examples of elements which have two or more oxidation states include Cu, Ga, Ge, Se, Pd, Ag, Au, etc.

When these substituent elements are used to be substituted for ceramic constituting elements, raw materials of the substituent elements may be added to the ceramic raw material that has a part of the raw material of the constituting elements substituted or reduced in advance by an amount corresponding to the substituted amount, and may be mixed and kneaded together. Then, the mixture is processed as usual, that is, it is formed in honeycomb shape, dried, degreased and fired in air. Thickness of the cell wall of the ceramic support is typically 300 μm or less. The smaller wall thickness is preferable since the heat capacity is correspondingly smaller. Alternatively, the ceramic raw material has a part of the raw material of the constituting elements to be substituted or reduced in advance by an amount corresponding to the substituted amount, and after kneading, forming and drying as usual, the dried product may be immersed in a solution containing the substituent elements. After the product is removed from the solution, it is dried, degreased and fired in air as usual. It is advantageous that, by adopting this method of immersing a molding in solution, substituent elements can be distributed on the surface of the molding in a greater amount, and as a result, element substitution can take place and a solid solution can be easily formed on the surface.

The amount of substituent elements is such that the total amount of the substituent elements is not less than 0.01% and not more than 50%, preferably in the range of 5-20%, of number of atoms of the substituted constituting elements. When the substituent element has a valence different from the ceramic constituting elements, lattice defects or oxygen defects are generated at the same time. By using plural substituent elements such that the sum of oxidation number of the substituent elements is equal to the sum of oxidation number of the substituted constituting elements, defects are not generated. Thus, by maintaining the overall valence unchanged, the catalyst component can be supported solely by binding to the substituent elements.

The NO oxidizing catalyst 1 can be obtained easily by causing noble metal element or base metal element to be supported as catalyst component by the ceramic support. When a catalyst component is to be supported, the ceramic support is immersed in a solution in which the catalyst component has been dissolved in a solvent. In this method, the catalyst component is chemically bound to the substituent element so that required amount of catalyst component can be supported without using γ-alumina coating. The solvent for supporting the catalyst component may be water, or an alcohol solvent such as methanol. The support impregnated with the catalyst component is then dried, and is fired at 300-800 ° C.

An ordinary known catalyst may be used as the NOx selective reduction type catalyst 2. In general, a coating layer of alumina or the like is formed on a ceramic support having a honeycomb structure with cordierite as a main component, and a catalyst component is supported on it. As the catalyst component, typically, noble metals such as Pt, Rh, Pd, etc., are used for reducing the NO₂ generated by the NO oxidizing catalyst 1 into N₂ using HC contained in the exhaust gas as a reducing agent. The NOx selective reduction type catalyst 2 may also be constructed in the same manner as the NO oxidizing catalyst 1 such that a ceramic support capable of supporting catalyst is used to directly support the catalyst component.

In the catalyst for an automobile as constructed above, the NO oxidizing catalyst 1 is a directly supported catalyst which has the catalyst component directly supported by the ceramic support via chemical bonding so that binding capability between the catalyst component and the ceramic support is greatly increased. As a result, the catalyst component can be evenly distributed over the surface of the ceramic support. Thus, even if the supported amount of the catalyst component is reduced to obtain the low reactivity required for the preceding stage of the NOx selective reduction type catalyst 2, a reduction of oxidizing capability due to increase of catalyst particle diameter by heat can be avoided. Thus, this catalyst has excellent thermal durability, and can sustain an initial cleaning capability for a long period. Since the NO oxidizing catalyst eliminates the need of conventional coating layer, it provides wider cell opening area so that it has lower thermal capacity and permits early activation and is also effective in reducing pressure loss.

As shown in FIG. 1(b) as a second embodiment of the invention, the catalyst can also be constructed as an integral unit of a two-stage catalyst having a low activity NO oxidizing catalyst layer 21 disposed in a preceding stage and a NOx selective reduction type catalyst layer 22 disposed in a following stage. Here, the NO oxidizing catalyst layer 21 in the preceding stage and the NOx selective reduction type catalyst layer 22 in the following stage have, respectively, same construction as the NO oxidizing catalyst 1 and the NOx selective reduction type catalyst 2 in the first embodiment. Also in this case, by providing the low activity NO oxidizing catalyst layer 21 in the preceding stage, good NOx cleaning capability in the following stage can be maintained for a long period. The integral one unit construction of the two-stage catalyst is effective in obtaining compact structure of a catalyst converter, and is also effective in reducing the cost.

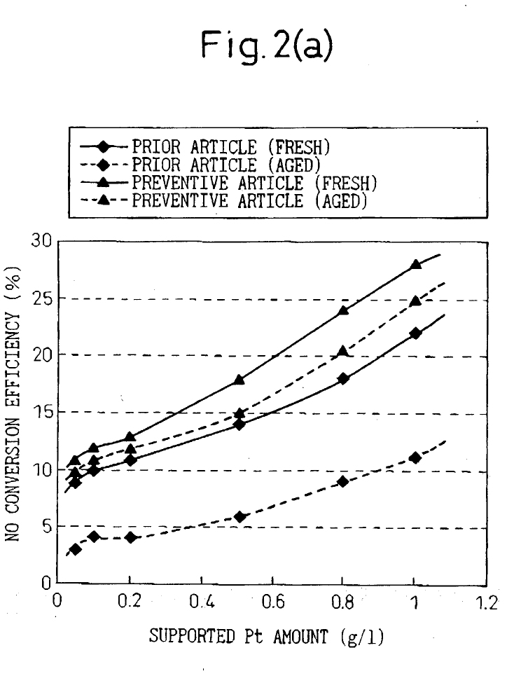

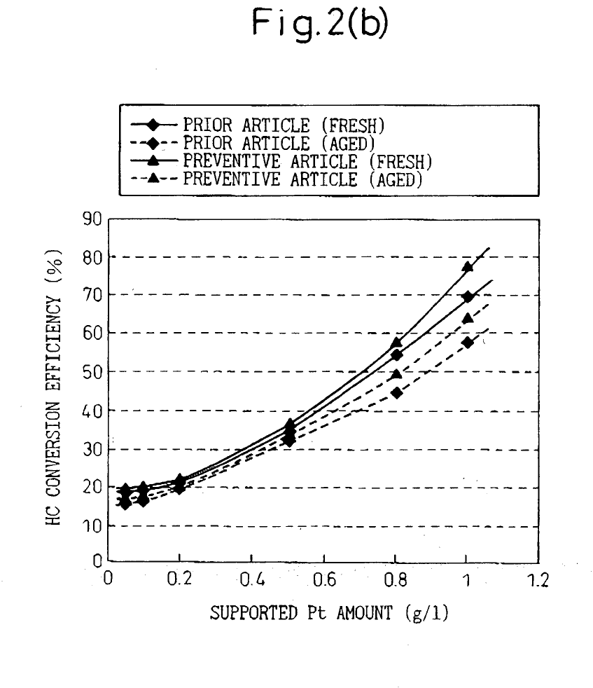

FIGS. 2(a) and 2(b) are views showing, respectively, the conversion efficiency from NO to NO₂ and the HC conversion efficiency for the case where Pt is directly supported as an active oxidizing species for the NO oxidizing catalyst 1 of the present invention. The NO oxidizing catalyst 1 was fabricated by impregnating a ceramic support formed into a honeycomb structure (cell wall thickness of 100 μm and cell density of 400 cpsi) having 5% of the cordierite constituting element Si substituted by W, with a tetraammineplatinum nitrate aqueous solution, and firing. Catalyst activity was evaluated when newly fabricated (new) and after durability test period of 24 hours at 1000 ° C. in air (post-durability). Conditions for the evaluation test such as composition of sample gas, etc., are as follows:

| | |
|---|---|
| CO2 | 8.8% |
| CO | 1100 ppm |
| O2 | 9.8% |
| THC | 800 ppm |
| NOx | 224 ppm |
| SV | 20000˜40000 |

In the Figure, the NO conversion efficiency and HC conversion efficiency are also shown for a NO oxidizing catalyst of conventional construction having a coating layer of γ-alumina formed thereon. The NO oxidizing catalyst of conventional construction was fabricated by mixing γ-alumina powder with tetraammineplatinum nitrate aqueous solution, firing, crushing, and dissolving it in water, and causing it to be supported by commonly known cordierite with γ-alumina as a binder. The conditions for the evaluation test were the same as in the preventive article.

As is evident from FIGS. 2(a) and 2(b), in general, the NO conversion efficiency tends to increase with an increase of supported amount of Pt, and the NO conversion efficiency of the oxidizing catalyst 1 (new) of the present invention is higher as a whole than that of conventional catalyst (new) with same supported amount. The reason for this is surmised to be that the catalyst of the present invention is a directly supported catalyst with highly dispersed catalyst component and hence has increased catalyst capability. Moreover, with the conventional catalyst, the NO conversion efficiency decreases greatly after the durability test period. In contrast, with the NO oxidizing catalyst of the present invention, a higher NO conversion efficiency is sustained after the durability test period than the conventional catalyst after the durability test, and it is seen that this catalyst has both high capability and high durability.

As can be seen from FIGS. 2(a) and 2(b), for the supported Pt amount of 0.05 g/L or more, the NO conversion efficiency is 10% or more. For the supported Pt amount of 0.08 g/L or more, the NO conversion efficiency of 10% or more is ensured even after the durability test period although the HC conversion efficiency also increases and the amount of HC that can be supplied to the NOx selective reduction type catalyst 2 on the downstream side decreases. If the amount of supported Pt is 1 g/L or less, the HC conversion efficiency can be suppressed at 80% or less. If this amount is 0.6 g/L or less, the HC conversion efficiency can be suppressed to 40% or less, and if this amount is 0.2 g/L or less, the HC conversion efficiency can be suppressed to 20% or less. Thus, it can be seen that, when a noble metal such as Pt is used, the supported amount is in the range of 0.05-1 g/L, preferably 0.08-0.6 g/L, and more preferably 0.08-0.2 g/L.

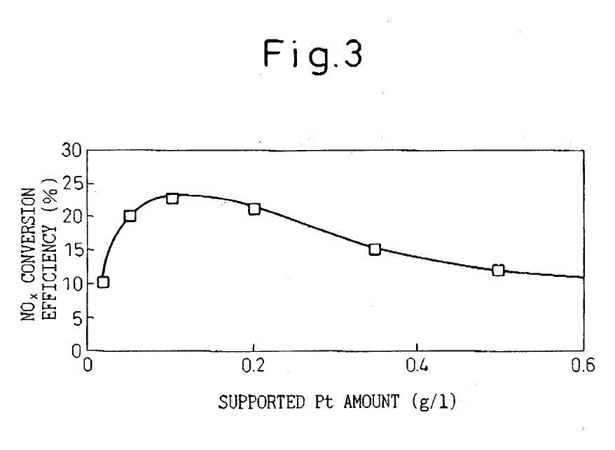

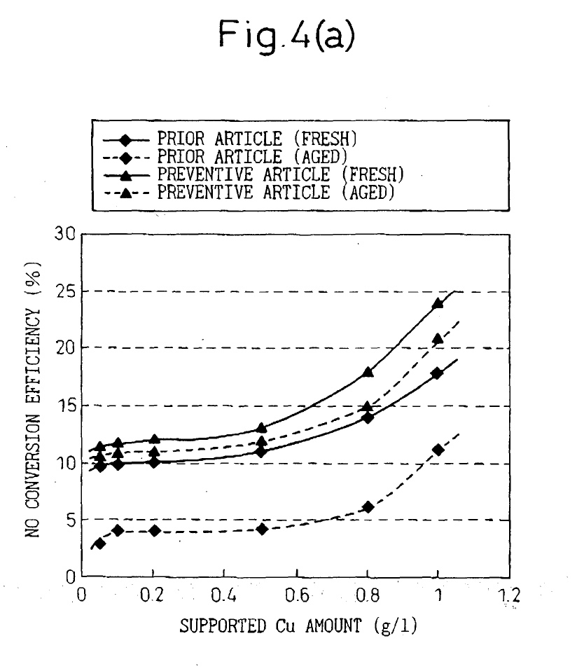

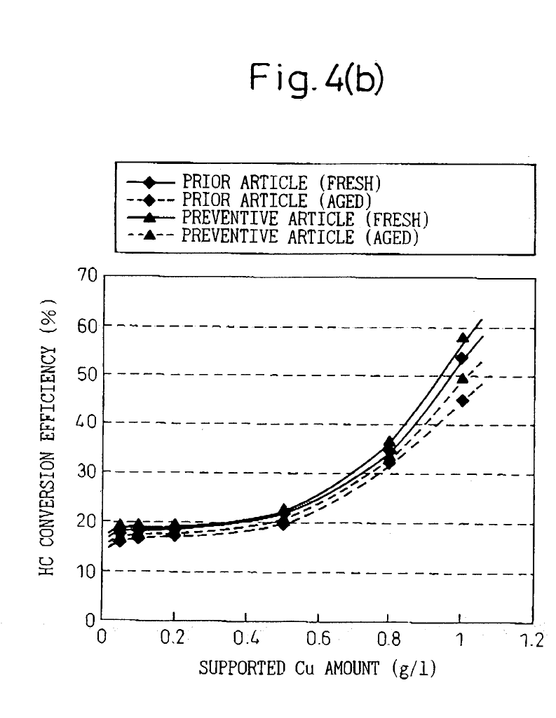

FIG. 3 is a view showing the relation between the supported amount of Pt in the NO oxidizing catalyst 1 and NOx conversion efficiency of the NOx selective reduction type catalyst 2 in the following stage. As can be seen from the Figure, with an increase in the supported amount of Pt, the NO conversion efficiency also increases. However, when the supported amount of Pt is near 0.1 g/L, the NO conversion efficiency reaches its peak, and with a further increase in the supported amount of Pt, the supplied amount of HC that serves as reducing agent decreases and NOx conversion efficiency again decreases. As can be seen from FIG. 4, in order to attain a NOx conversion efficiency of 10% or more, the supported amount of Pt needs to be in the range of 0.08-0.6 g/L, and with the supported amount of Pt in the range of 0.08-0.2 g/L, a NOx conversion efficiency of 20% or more can be attained.

FIGS. 4(a) and 4(b) are views showing the evaluation result when Cu is supported in place of Pt. A similar tendency can be recognized also in this case and, with a supported amount of 0.05 g/L or more, a NO conversion efficiency of 10% or more can be obtained. With supported CU amount of 0.2 g/L or more, a NO conversion efficiency of 10% or more can be ensured even after durability test period. For a supported Cu amount of 10 g/L or less, the HC conversion efficiency can be suppressed to 60% or less, for a supported Cu amount of 8 g/L or less, the HC conversion efficiency can be suppressed to 40% or less, and for a supported Cu amount of 5 g/L or less, the HC conversion efficiency can be suppressed to 20% or less. Thus, it can be seen that, when a base metal such as Cu is used, the supported amount needs to be in the range of 0.05-10 g/L, preferably 0.2˜8 g/L, and more preferably 0.2˜5 g/L.

In the embodiment described above, a substituent element is introduced in the substrate ceramic to obtain a ceramic capable of directly supporting a catalyst component. However, the ceramic support may have a multiplicity of fine pores capable of directly supporting a catalyst component on the surface of the substrate ceramic. Specifically, a fine pore is at least one of defect (oxygen vacancy or lattice defect) of the ceramic crystal lattice, a fine crack formed on the surface of the ceramic, and a vacancy of element constituting the ceramic. These fine pores may be at least one type formed in the ceramic, or a combination of plural types may be formed. In order to be capable of supporting a catalyst component without forming a coating layer of a highly specific surface of γ-alumina, etc., it is desirable that the diameter or the width of the fine pores is not greater than 1000 times, preferably 1-1000 times, the diameter of the catalyst component ion (typically, about 0.1 nm). It is desirable that the depth of the fine pore is not less than ½ of the diameter of the catalyst component ion, typically not less than 0.05 nm. In order to be capable of supporting comparable amount of catalyst component as before (1.5 g/L), it is desired that the number of the fine pores is not less than 1×10¹¹/L, preferably not less than 1×10¹⁶/L, and more preferably not less than 1×10¹⁷/L.

As fine pores formed on the surface of a ceramic, defects of crystal lattice include oxygen vacancy and lattice defect (metal vacancy and lattice strain). The oxygen vacancy is a defect caused by deficiency of oxygen for constituting the crystal lattice, and a catalyst component can be supported on the fine pore that is formed where the oxygen is lacking. The lattice defect is a defect formed when more oxygen is incorporated than is required to constitute a ceramic crystal lattice, and a catalyst component can be supported on a fine pore which is formed by strain or metal vacancy of the crystal lattice.

More specifically, if a cordierite honeycomb structure contains not less than 4×10⁻⁶%, preferably not less than 4×10⁻⁵%, of cordierite crystal having one or more of at least one of oxygen vacancy and lattice defect in unit crystal lattice, or if at least one of oxygen vacancy and lattice defect is contained 4×10⁻⁸, preferably 4×10⁻⁷, in unit crystal lattice of cordierite crystal, the number of fine pores in the ceramic support is equal to or greater than specified number described above. Next, details of the fine pores and a method for forming them will be described.

In order to form oxygen vacancies in a crystal lattice, as is disclosed in Japanese Patent Application No. 2000-104994, in the process of forming, degreasing, and firing the cordierite raw material containing Si source, Al source, and Mg source, one of following methods may be adopted: \mathring{1} firing is performed in a reduced pressure or reducing atmosphere, \mathring{2} a compound not containing oxygen is used in at least a part of raw material, and by firing in an atmosphere of low oxygen concentration, a firing atmosphere or a starting raw material is made oxygen deficient, or \mathring{3} at least one of ceramic constituting elements other than oxygen is substituted partially by an element with a valency smaller than the constituting element. In the case of cordierite, constituting elements are Si (4+), Al (3+), Mg (2+) which have positive charge. If these element are substituted by an element having smaller valency, positive electric charges become deficient corresponding to the difference of valency and the substituted amount, and to maintain electrical neutrality of the crystal lattice, O (2−) having negative charge is released and an oxygen vacancy is thereby formed.

In order to form lattice defects, \mathring{4} a part of ceramic constituting elements other than oxygen is substituted by an element having a valency larger than the constituting element. When at least a part of cordierite constituting elements Si, Al, Mg is substituted by an element having a larger valency than the constituting element, an excess positive electric charge is generated corresponding to the difference in the valency and the substituted amount, and to maintain electrical neutrality of the crystal lattice, a required amount of O (2−) having a negative charge is incorporated. The incorporated oxygen impedes regular arrangement of the cordierite crystal lattice so that a lattice strain is formed. In this case, firing is performed in air to supply adequate oxygen. In order to maintain electrical neutrality, a part of Si, Al, Mg can be released and vacancies formed. As the size of these defects is considered to be not greater than a few Å, an ordinary measurement method for measuring specific surface area such as BET method using nitrogen molecules cannot be applied to these defects for measuring specific surface area.

The number of oxygen vacancies and lattice defects is correlated with the oxygen content contained in the cordierite and, in order to support a required amount of a catalyst component, the content of oxygen is made less than 47% by weight (oxygen vacancy) or more than 48% by weight (lattice defects). When oxygen vacancy is formed and content of oxygen becomes less than 47% by weight, the amount of oxygen contained in the unit cordierite crystal lattice becomes less than 17.2, and the lattice constant of the b₀ axis of the cordierite crystal becomes smaller than 16.99. Also, when lattice defect is formed and oxygen content becomes more than 48% by weight, the amount of oxygen contained in the unit cordierite crystal lattice becomes more than 17.6, and the lattice constant of the b₀ axis of the cordierite crystal becomes larger than 16.99.

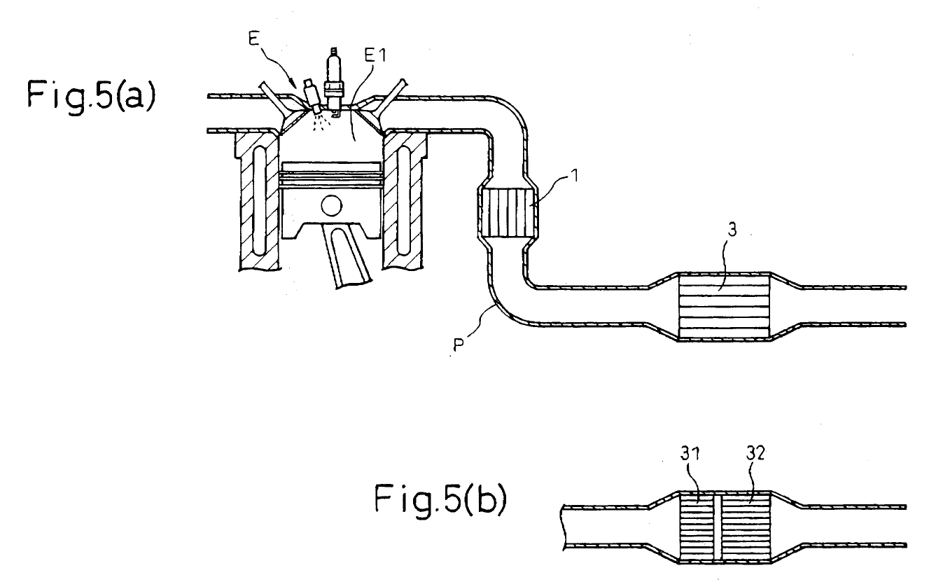

FIG. 5(a) is a view showing the construction of a catalyst for an automobile according to a third embodiment of the present invention.

In FIG. 5(a), an exhaust pipe P as a passageway for an exhaust gas is connected to a combustion chamber E1 of the vehicle internal combustion engine E and, midway, a low activity NO oxidizing catalyst 1 as the catalytic body on the upstream side and a diesel particulate filter with a catalyst (hereinafter referred to as DPF with a catalyst) 3 are disposed. The low activity NO oxidizing catalyst 1 has the same construction as the embodiments 1 and 2 described above, and has low oxidizing activity capable of oxidizing NO in the exhaust gas into NO₂. The generated NO₂ is supplied to the DPF with catalyst 3 on the downstream side, and is used as an oxidizing agent for particulate.

As the DPF with catalyst 3, a known wall flow type is used. In general, a porous ceramic is formed into a honeycomb structure, and at both ends of the honeycomb structure, an inlet port and outlet port of each cell forming passageway of an exhaust gas are alternately sealed at the end of the structure to obtain a filter. Particulates in the exhaust gas, mainly soot, are captured in passing through the porous partition wall. On the surface of the ceramic, an oxidizing catalyst for promoting combustion of soot is provided via a coating layer of γ-alumina, etc. Thus, using NO₂ supplied by the NO oxidizing catalyst in the preceding stage as an oxidizing agent, an oxidation reaction of soot is started at a relatively low temperature by the activity of the oxidizing catalyst, and the captured soot can be burnt continuously.

In this construction, too, by using a low activity NO oxidizing catalyst 1 to convert NO into NO₂, NO₂ can be stably supplied to the DPF with catalyst 3 on the downstream side. Here, the NO oxidizing catalyst 1 is a directly supported catalyst in which a catalyst component is directly supported on a ceramic support, so that, even if the amount of supported catalyst component is decreased to obtain desired low activity, the catalyst is not easily deteriorated, and stable burning of soot can be maintained for a long period. As the catalyst is of low activity, the generation of sulfates can be suppressed and amount of an exhaust gas from the system as a whole can be effectively decreased. Since the NO oxidizing catalyst 1 is a directly supported catalyst, the catalyst eliminates the need of a conventional coating layer, and has a reduced thermal capacity and low pressure loss.

As shown in FIG. 5(b) as a fourth embodiment of the present invention, the catalyst may be constructed as an integral two-stage catalyst with a NO oxidizing catalyst layer 31 disposed in a preceding stage and a DPF layer 32 with a catalyst disposed in a following stage, to obtain same effect. In place of the DPF 3 with a catalyst on the downstream side in FIG. 5(a) or the DPF layer 32 with a catalyst in the following stage in FIG. 5(b), a NOx cleaning DPF may be provided. The NOx cleaning DPF is a DPF that supports a NO catalyst and cleans NOx in an exhaust gas with the NO catalyst while capturing particulates such as soot. In this case, too, by using a NO oxidizing catalyst 1 in the preceding stage to convert NO to NO₂, NOx can be cleaned efficiently. When the NOx cleaning DPF is used, NO₂ need not be used in burning soot as an oxidizing agent.

As has been described in the foregoing, according to the present invention, a low activity NO oxidizing catalyst is provided in a stage preceding a NOx selective reduction type catalyst, a DPF with a catalyst, or a NOx cleaning DPF. By constructing this NO oxidizing catalyst as a directly supported catalyst, a catalyst for an automobile having excellent cleaning capability and excellent durability can be realized.

What is claimed is:

1. A catalyst for an automobile comprising a plurality of catalytic bodies provided in an exhaust gas passage of an internal combustion engine for a vehicle, wherein, among said plurality of catalytic bodies, a low activity oxidizing catalytic body is disposed on the upstream side for oxidizing a part of an exhaust gas and supplying the same to a catalytic body on the downstream side, characterized in that said catalytic body on the upstream side is a directly supported catalyst which uses a ceramic support capable of directly supporting a catalyst on the surface of the substrate ceramic, and directly supports a catalyst component having a low oxidizing activity on the ceramic support.

2. A catalyst for an automobile comprising an integral multi-stage catalyst which has a plurality of catalyst layers integrated in one unit provided in an exhaust gas passage of an internal combustion engine for a vehicle, wherein, among said plurality of catalyst layers, a low activity oxidizing catalyst layer is disposed in a preceding stage for oxidizing a part of an exhaust gas and supplying same to a catalyst layer in a following stage, characterized in that said catalyst layer in the preceding stage is a directly supported catalyst which uses a ceramic support capable of directly supporting a catalyst on the surface of the substrate ceramic, and directly supports a catalyst component having a low oxidizing activity on the ceramic support.

3. A catalyst for an automobile according to claim 1 or 2, wherein said catalytic body on the upstream side or said catalyst layer in the preceding stage has a low oxidizing activity such that it is capable of oxidizing NO in an exhaust gas to NO₂, and supplying at least a part of the HC unoxidized to said catalytic body on the downstream side or said catalyst layer in the following stage.

4. A catalyst for an automobile according to claim 3, wherein said catalytic body on the downstream side or said catalyst layer in the following stage is a NOx selective reduction type catalyst for cleaning NO₂ supplied from said catalytic body on the upstream side or said catalyst layer in the preceding stage by reduction with HC in the exhaust gas.

5. A catalyst for an automobile according to claim 3, wherein said catalytic body on the downstream side or said catalyst layer in the following stage is a particulate filter which uses NO₂ supplied from said catalytic body on the upstream side or said catalyst layer in the preceding stage as an oxidizing agent to burn soot in the captured exhaust gas.

6. A catalyst for an automobile according to claim 1, wherein the oxidizing catalyst component supported by said catalytic body on the upstream side contains a noble metal element or a base metal element.

7. A catalyst for an automobile according to claim 6, wherein the oxidizing catalyst component supported by said catalytic body on the upstream side contains a noble metal element and the supported amount is 0.05˜1.0 g/L.

8. A catalyst for an automobile according to claim 6, wherein the oxidizing catalyst component supported by said catalytic body on the upstream side contains a base metal element and the supported amount is 0.05-10 g/L.

9. A catalyst for an automobile according to 2, wherein the oxidizing-catalyst component supported by, said catalyst layer in the preceding stage contains a noble metal element or a base metal element.

10. A catalyst for an automobile according to claim 9, wherein the oxidizing catalyst component supported by said catalyst layer in the preceding stage contains a noble metal element and the supported amount is 0.05˜1.0 g/L.

11. A catalyst for an automobile according to claim 9, wherein the oxidizing catalyst component supported by said catalyst layer in the preceding stage contains a base metal element and the supported amount is 0.05-10 g/L.

12. A catalyst for an automobile according to claim 1, wherein said ceramic support has at least one or more of elements constituting the substrate ceramic substituted by an element other than the constituting elements, and is capable of directly supporting a catalyst component on this substituent element.

13. A catalyst for an automobile according to claim 12, wherein said catalyst component is supported on said substituent element via chemical bonding.

14. A catalyst for an automobile according to claim 12, wherein said substituent element is at least one or more elements having d-electron orbit or f-electron orbit in the electronic orbit configuration.

15. A catalyst for an automobile according to claim 2, wherein said ceramic support has at least one or more of elements constituting the substrate ceramic substituted by an element other than the constituting elements, and is capable of directly supporting a catalyst component on this substituent element.

16. A catalyst for an automobile according to claim 15, wherein said catalyst component is supported on said substituent element via chemical bonding.

17. A catalyst for an automobile according to claim 15, wherein said substituent element is at least one or more elements having d-electron orbit or f-electron orbit in the electronic orbit configuration.

18. A catalyst for an automobile according to claim 1, wherein said ceramic support has a multiplicity of fine pores capable of directly supporting a catalyst on the surface of substrate ceramic, and is capable of directly supporting a catalyst component on these pores.

19. A catalyst for an automobile according to claim 18, wherein said fine pores consist of at least one of a defect of the ceramic crystal lattice, a fine crack on the surface of the ceramic, and a vacancy of elements constituting the ceramic.

20. A catalyst for an automobile according to claim 19, wherein the width of said fine cracks is not greater than 100 nm.

21. A catalyst for an automobile according to claim 19, wherein said fine pores have a diameter or a width not greater than 1000 times the diameter of the supported catalyst ions, and the number of said fine pores is not less than 1×10¹¹/L.

22. A catalyst for an automobile according to claim 2, wherein said ceramic support has a multiplicity of fine pores capable of directly supporting a catalyst on the surface of substrate ceramic, and is capable of directly supporting a catalyst component on these pores.

23. A catalyst for an automobile according to claim 22, wherein said fine pore consists of at least one of a defect of the ceramic crystal lattice, a fine crack on the surface of the ceramic, and a vacancy of elements constituting the ceramic.

24. A catalyst for an automobile according to claim 23, wherein the width of said fine cracks is not greater than 100 nm.

25. A catalyst for an automobile according to claim 23, wherein said fine pores have diameter or width not greater than 1000 times the diameter of the supported catalyst ions, and the number of said fine pores is not less than 1×10¹¹/L.

26. A catalyst for an automobile according to claim 1 or 2, wherein said substrate ceramic of said ceramic support contains cordierite as a component.
